(19) United States
(12) Patent Application Publication
(10) Pub. No.: US 2014/0181873 A1
(43) Pub. Date: Jun. 26, 2014

(54) WIDGET INTERFACE MANAGEMENT

(71) Applicant: KT CORPORATION, SEONGNAM-SI (KR)

(72) Inventor: Sung Woo KIM, Seoul (KR)

(73) Assignee: KT CORPORATION, SEONGNAM-SI (KR)

(21) Appl. No.: 14/140,646

(22) Filed: Dec. 26, 2013

(30) Foreign Application Priority Data
Dec. 26, 2012 (KR) 10-2012-0153214

(51) Int. Cl. H04N 21/81; H04N 21/482; H04N 21/2381

(52) U.S. Cl. CPC H04N 21/8173; H04N 21/2381; H04N 21/482
USPC 725/53

(57) ABSTRACT

In one example embodiment, a system includes a server configured to: receive, from a first device, a request to generate a widget interface and a search parameter for video content, generate a list of video content corresponding to the search parameter for the video content, generate the widget interface associated with the generated list of video content, and transmit the generated widget interface; and a second device configured to: receive the transmitted widget interface, receive an input to select the transmitted widget interface from among a plurality of widget interfaces, and display the list of the video content associated with the selected widget interface.

### TECHNICAL FIELD

The embodiments described herein pertain generally to management of widget interfaces.

### BACKGROUND

An IPTV (Internet Protocol Television) service provider may provide a service that integrates security of a telecommunication network, the content of a broadcast television network, and the ubiquity of the Internet; and may further provide voice, data, and video services over one connection simultaneously. Therefore, a user may use a client device to not only access the Internet, and watch TV, but also enjoy more data, voice, and video integrated services through the IPTV service, serially or in parallel.

### SUMMARY

In one example embodiment, a system may include a server configured to: receive, from a first device, a request to generate a widget interface and a search parameter for video content, generate a list of video content corresponding to the search parameter for the video content, generate the widget interface associated with the generated list of video content, and transmit the generated widget interface; and a second device configured to: receive the transmitted widget interface, receive an input to select the transmitted widget interface from among a plurality of widget interfaces, and display the list of the video content associated with the selected widget interface.

In another example embodiment, a server may include a receiver configured to receive, from a first device, a request to generate a widget interface and a search parameter for video content; an icon manager configured to determine an icon that represents the received search parameter for the video content; a video content manager configured to determine a list of the video content that corresponds to the search parameter for the video content; a widget interface generator configured to generate the widget interface that includes the icon and the list of the video content; and a widget interface transmitter configured to transmit the generated widget interface to a second device.

In yet another example embodiment, a device may include: a widget receiver configured to receive, from a server, a plurality of widget interfaces that are associated with a plurality of lists of video content; a widget display unit configured to display the received plurality of widget interfaces; an input receiver configured to receive an input to select a widget interface from among the displayed plurality of widget interfaces; and an information display unit configured to display a list of video content that is associated with the selected widget interface.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent from the following detailed description. The use of the same reference numbers in different figures indicates similar or identical items.

FIG. 1 shows an example system configuration in which widget interface management may be implemented, in accordance with various embodiments described herein;

FIG. 2 shows illustrative examples of widget interfaces, in accordance with various embodiments described herein;

FIG. 3 shows another illustrative example of a widget interface, in accordance with various embodiments described herein;

FIGS. 4A to 4C show an illustrative example of a device by which at least portions of widget interface management may be implemented, in accordance with various embodiments described herein;

FIGS. 5A to 5C show another illustrative example of a device by which at least portions of widget interface management may be implemented, in accordance with various embodiments described herein;

FIGS. 6A to 6C show still another illustrative example of a device by which at least portions of widget interface management may be implemented, in accordance with various embodiments described herein;

FIGS. 7A to 7C show an illustrative example of a device by which at least portions of widget interface management may be implemented, in accordance with various embodiments described herein;

FIG. 8 shows an example configuration of a server by which at least portions of widget interface management may be implemented, in accordance with various embodiments described herein;

FIG. 9 shows an example configuration of a device by which at least portions of widget interface management may be implemented, in accordance with various embodiments described herein;

FIG. 10 shows an example processing flow of operations by which at least portions of widget interface management may be implemented, in accordance with various embodiments described herein;

FIG. 11 shows another example processing flow of operations by which at least portions of widget interface management may be implemented, in accordance with various embodiments described herein; and

FIG. 12 shows an illustrative computing embodiment, in which any of the processes and sub-processes of widget interface management may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

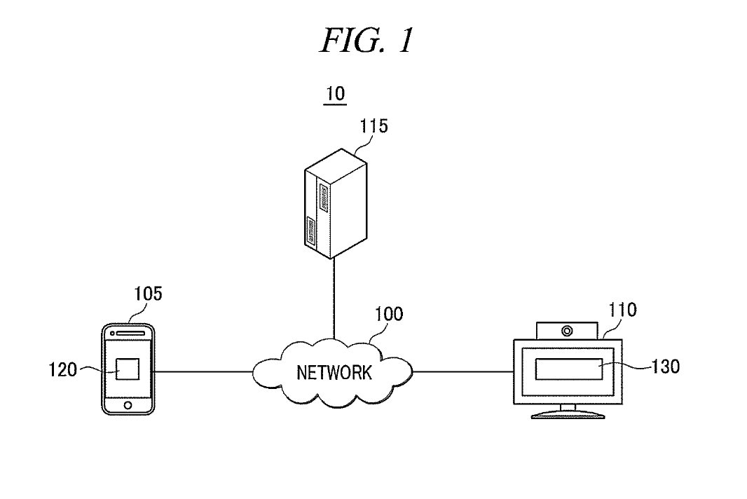

FIG. 1 shows an example system configuration 10 in which widget interface management may be implemented, in accordance with various embodiments described herein. As depicted in FIG. 1, system configuration 10 may include, at least, a first device 105, a second device 110, and a server 115.

Network 100 may refer to a communications network that may be configured to communicatively couple two or more of first device 105, second device 110, and server 115. Non-limiting examples of network 100 may include a wired network protocol, such as LAN (Local Area Network), WAN (Wide Area Network), VAN (Value Added Network), etc.; or various other wireless network protocols, such as a mobile radio communication network including at least one of a 3rd generation (3G) mobile telecommunications network, a 4th or 5th generation mobile telecommunications network, any other mobile telecommunications networks, a satellite network, WiBro (Wireless Broadband Internet), a Wi-Fi network, Mobile WiMAX, HSDPA (High Speed Downlink Packet Access) or the like.

As non-limiting examples, respective ones of first device 105 and second device 110 may refer to a notebook computer; a smart television; a set-top box that may or may not have a display coupled thereto; a personal computer; a smart phone; a tablet computer; a phablet device; and/or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals, that is capable of, at least, receiving and/or playing internet protocol television content. For example, but not as a limitation, the internet protocol television content may include at least one of video-on-demand content, real-time broadcasting content or user interactive content (e.g., games).

First device 105 may be configured to transmit a request, to server 115, to generate a widget interface. The request may be accompanied by a search parameter for video content. For example, but not as a limitation, the video content may include video-on-demand (VOD) content. Further, for example, the search parameter for video content may refer to a keyword or a phrase that may represent the video content and may be used to search for the video content. For example, but not as a limitation, first device 105 may be configured to host a user interface 120 for an application that executes on server. Further, first device 105 may be configured to display user interface 120 on a display that may be part of, or communicatively coupled to, first device 105. First device 105 may be further configured to receive an input to transmit the request and an input to select various search parameters via displayed user interface 120. Further, first device 105 may be configured to transmit, to server 115, the request and the search parameter for the video content via displayed user interface 120.

Second device 110 may be configured to download multiple widget interfaces from server 115, and to display the downloaded multiple widget interfaces on a display that may be part of, or communicatively coupled to, second device 115. Each of the multiple widget interfaces may be associated with a list of video content that corresponds to the search parameter, which may be transmitted from first device 105 to server 115. Further, each of the multiple widget interfaces may include an icon that may represent the search parameter, which may be transmitted from first device 105 to server 115. For example, the icon may refer to an image, a keyword, or a representation that represents the search parameter for the video content. Further, the multiple widget interfaces may correspond, respectively, to at least one of the following functions or features: view a review of video content, view a synopsis of video content, view a number or range of numbers of recommendations for video content, view marketing materials regarding video content (e.g., a poster of video content), or view other information regarding video content (e.g., information regarding an actor of video content).

Further, second device 110 may be configured to receive an input to select a widget interface 130 from among the downloaded multiple widget interfaces. For example, second device 10 may be configured to receive, e.g., a touch input, from a user of second device 110, to select widget interface 130. Second device 110 may be configured to then display selected widget interface 130 that includes the list of the video content and the icon on the display.

Further, second device 110 may be configured to receive an input to select video content from the list of the video content, which may be displayed by second device 110. For example, second device 110 may be configured to receive, e.g., a touch input from the user of second device 110, to select the video content from the list of the video content. Second device 110 may be further configured to transmit a request for the selected video content to server 115. Second device 110 may be configured to receive the selected video content from server 115 in response to the request, and then to play or reproduce the received video content on the display.

Further, second device 110 may be configured to receive, from server 115, information regarding the selected video content, if second device 110 transmits the request for the selected video content to server 115. Further, second device 110 may be configured to display the received information regarding the selected video content on the display. As non-limiting examples, the information regarding the selected video content may include at least one of a review of the selected video content, a synopsis of the selected video content, a number or range of numbers of recommendations for the selected video content, a poster of the selected video content, or information about an actor of the selected video content.

Server 115 may refer to one or more servers or apparatuses hosted and/or supported by a service providing organization or entity that provides real-time broadcasting services, video-on-demand (VOD) services, and/or user interactive services (e.g., games) to first device 105 and second device 110. Non-limiting examples of server 115 may include an Internet service provider, i.e., ISP; application service provider, i.e., ASP; storage service provider, i.e., SSP; and television service provider, i.e., cable TV, DSL and DBS.

Server 115 may be configured to receive, from first device 105, a request to generate a widget interface and a search parameter for video content. Further, server 115 may be configured to generate and/or determine a list of video content that corresponds to the received search parameter. In some embodiments, server 115 may be configured to identify the video content that corresponds to the search parameter, and to generate the list of the video content that may include at least some of the identified video content. For example, server 115 may be configured to search for video content that corresponds to the search parameter, and to generate a list of video content that fulfills the search parameter to some extent. Further, server 115 may be configured to transmit the generated list of the video content to first device 105 from which the search parameter was transmitted. Further, server 115 may be configured to receive, from first device 105, a selecting to select video content, singular or plural, from the generated list of the video content. Server 115 may be configured to then generate and transmit a list of the selected video content to second device 110.

Further, server 115 may be configured to determine and/or generate an icon that may be configured to represent the search parameter for the video content. Server 115 may be configured to then generate the widget interface that includes the generated list of the selected video content and the determined icon. Further, server 115 may be configured to transmit the generated widget interface to second device 110.

In some embodiments, server 115 may be configured to receive, from second device 110, a request for video content that is selected from the list of the video content, which is displayed on second device 110. Further, server 115 may be configured to transmit the requested video content to second device 110.

Further, server 115 may be configured to transmit, to second device 110, information regarding the requested video content. As non-limiting examples, the information regarding the requested video content may include at least one of a review of the requested video content, a synopsis of the requested video content, a number of recommendations for the requested video content, a poster of the requested video content, or information about an actor of the requested video content. For example, the information regarding video content may be stored in a corresponding memory of server 115. Alternatively, server 115 may be configured to receive the information regarding video content from a data source (e.g., the Internet or a cloud data center), and to transmit the received information to second device 110.

Thus, FIG. 1 shows example system configuration 10 in which widget interface management may be implemented, in accordance with various embodiments described herein.

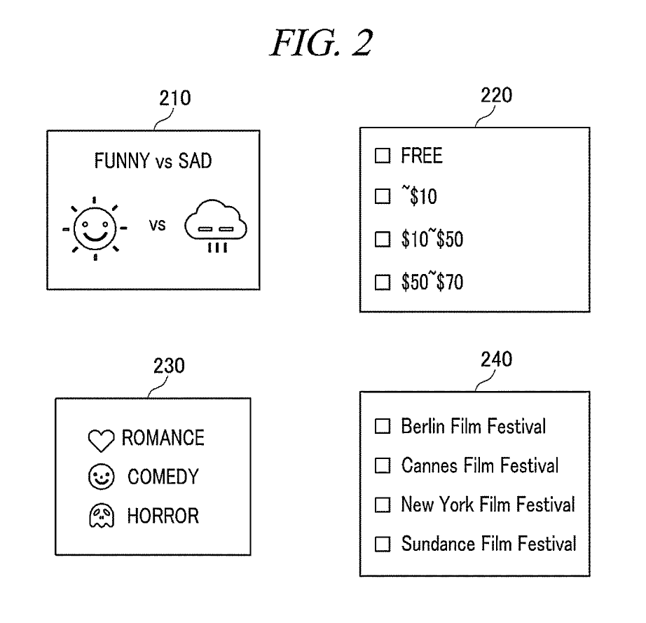

FIG. 2 shows illustrative examples of widget interfaces, in accordance with various embodiments described herein. Server 115 may be configured to receive, from first device 105, a request to generate a widget interface and a search parameter for video content. Further, server 115 may be configured to generate and/or determine a list of video content that corresponds to the search parameter. Further, server 115 may be configured to then generate a widget interface 210, 220, 230 or 240 that includes the generated list of the video content and the icon. For example, but not as a limitation, as depicted in FIG. 2, first widget interface 210 may be associated with video content that corresponds to a search parameter for video content which may be suitable for a happy mood and video content that corresponds to a search parameter for video content which may be suitable for a serious mood. Further, a second widget interface 220 may be associated with video content that corresponds to a search parameter for video content which may be played or reproduced for free, and/or with video content that may be played or reproduced for various fees. As examples, second widget interface 220 may include a menu of video content that may be played or reproduced for less than ten dollars, video content that may be played or reproduced for from ten dollars to fifty dollars, and video content that may be played or reproduced for from fifty dollars to seventy dollars. Further, a third widget interface 230 may be associated with various genres. As examples, third widget interface 230 includes a menu of romantic video content, comic video content, and horror video content. Further, a fourth widget interface 240 may be associated with video content that may be associated with various reviews, ratings, accolades, and/or sources thereof. As examples, fourth widget interface 240 includes a menu of video content associated with the Berlin Film Festival (e.g., video content that received an award in the Berlin Film Festival), video content that may be associated with the Cannes Film Festival (e.g., video content that received an award in the Cannes Film Festival), video content that may be associated with the New York Film Festival (e.g., video content that received an award in the New York Film Festival), and Sundance Film Festival (e.g., video content that received an award in the Sundance Film Festival).

Thus, FIG. 2 shows illustrative examples of widget interfaces, in accordance with various embodiments described herein.

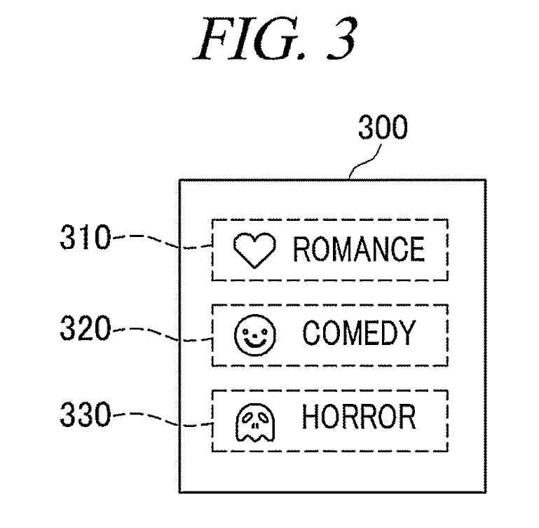

FIG. 3 shows another illustrative example of a widget interface 300, in accordance with various embodiments described herein. Server 115 may be configured to receive, from first device 105, a request to generate a widget interface and a search parameter for video content. Further, server 115 may be configured to generate and/or determine a list of video content that corresponds to the search parameter. Further, server 115 may be configured to determine and/or generate at least one icons 310, 320 and 330 that may be configured to represent the search parameter for the video content. Server 115 may be configured to then generate a widget interface 300 that includes the generated list of the video content and icons 310, 320 and 330. For example, as depicted in FIG. 3, widget interface 300 may include a first icon 310 that may be configured to represent a search parameter for romantic video content, and therefore first icon 310 may be displayed next to a resulting list of romantic video content. Further, widget interface 300 may include a second icon 320 that may be configured to represent a search parameter for comedic video content, and therefore second icon 320 may be displayed next to a resulting list of comedic video content. Further, widget interface 300 may include a third icon 330 that may be configured to represent a search parameter for horror video content, and therefore third icon 330 may be displayed next to a resulting list of horror video content.

Thus, FIG. 3 shows another illustrative example of widget interface 300, in accordance with various embodiments described herein.

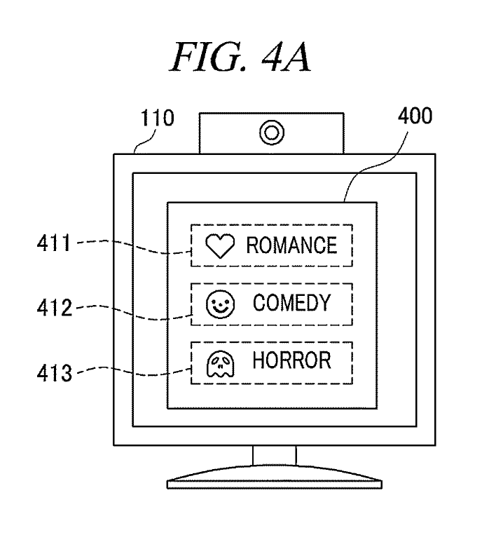

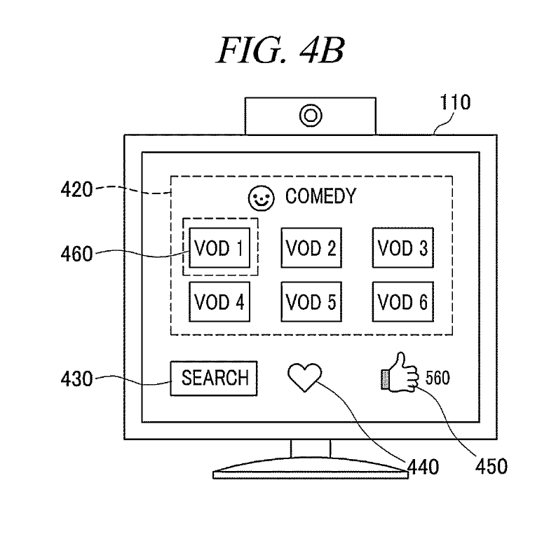

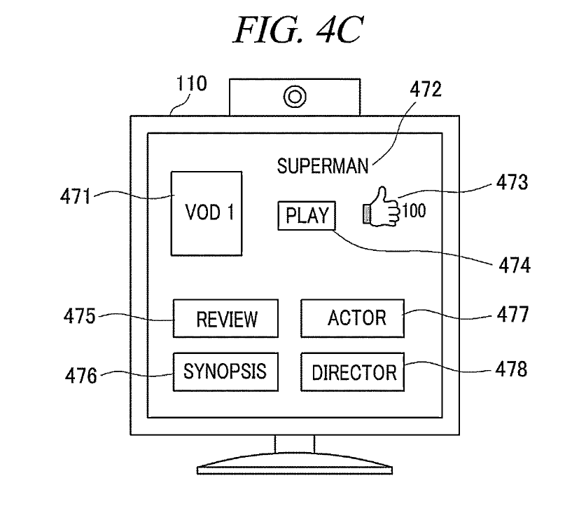

FIGS. 4A to 4C show an illustrative example of a device by which at least portions of widget interface management may be implemented, in accordance with various embodiments described herein. Second device 110, described above with regard to FIG. 1, may be configured to display a widget interface that includes multiple icons, each of which represents a search parameter for video content, on a display that may be a part of, or communicatively coupled to, second device 110. For example, as depicted in FIG. 4A, second device 110 may be configured to display a widget interface 400 that includes three icons 411, 412 and 413, each of which represents a search parameter for video content. For example, first icon 411 may represent a search parameter for romantic video content. Second icon 412 may represent a search parameter for comedic video content. Further, third icon 413 may represent a search parameter for horror video content.

Further, second device 110 may be configured to display, on the display, a list of video content that may be associated with an icon selected by a user of second device 110, when second device 110 receives a user input to select the icon from among the multiple icons. For example, as depicted in FIG. 4B, second device 110 may be configured to display a video content list 420 that includes a menu of multiple video-on-demand (VOD) content selections and is associated with second icon 412, when second device 110 receives an input to select second icon 412.

Further, second device 110 may be configured to display a first icon that may be configured to receive input instructions to search for video content that may be associated with the widget interface. For example, second device 110 may be further configured to display a second icon that may be configured to receive a user input to recommend the widget interface and a third icon that may be configured to show a number of recommendations for the widget interface. The recommendations for the widget interface may be made by a user of second device 110 or other users. For example, as depicted in FIG. 4B, second device 110 may be configured to display an icon 430 that may be configured to receive a user input to search for video content that may be associated with widget interface 400. For example, a search box or a search interface that may be configured to receive a keyword may be displayed on second device 110, if second device 110 receives a user input to select icon 430. Further, second device 110 may be configured to display an icon 440 that may be configured to receive a user input to recommend widget interface 400. For example, if a user of second device 110 is content with widget interface 400 and wants to recommend widget interface 400 to other users, the user of second device 110 makes a user input to select icon 440. Further, second device 110 may be configured display an icon 450 that may be configured to show an accumulated number of recommendations for widget interface 400, which is made by other users.

Further, second device 110 may be configured to transmit, to server 115, a user input to select video content from the list of the video content, when second device 110 receives the user input to select the video content from the list of the video content. Further, second device 110 may be configured to receive, from server 115, information regarding the selected video content in response of the transmitted user input. Further, second device 110 may be configured to display, on the display, the received information. For example, but not as a limitation, if second device 110 receive an input to select video content 460 from video content list 420, as depicted in FIG. 4C, second device 110 may be configured to transmit the received input to server 115. Further, second device 110 may be configured to receive, from server 115, information regarding a poster, a title, a number of recommendations, a review, a synopsis, an actor or a director of selected video content 460. Further, second device 110 may be configured to then display a poster 471 of selected video content 460, a title 472 of selected video content 460, a number 473 of recommendations for selected video content 460, a play icon 474 that may be configured to execute to play selected video content 460, a review 475 for selected video content 460, a synopsis 476 of selected video content 460, an icon 477 to receive an input to show information regarding an actor/actress of selected video content 460, and an icon 478 to receive an input to show information regarding a director of selected video content 460. For example, if a user of second device 110 wants to play selected video content 460, the user of second device 110 makes a user input to select play icon 474. Then, video content 460 may be reproduced on second device 110. Further, if a user of second device 110 wants to see information regarding an actor/actress of selected video content 460, the user of second device 110 makes a user input to select play icon 477. Then, the information regarding the actor/actress of selected video content 460 may be displayed on second device 110. Further, if a user of second device 110 wants to see information regarding a director of selected video content 460, the user of second device 110 makes a user input to select play icon 478. Then, the information regarding the director of selected video content 460 may be displayed on second device 110.

Thus, FIGS. 4A to 4C show an illustrative example of a device by which at least portions of widget interface management may be implemented, in accordance with various embodiments described herein.

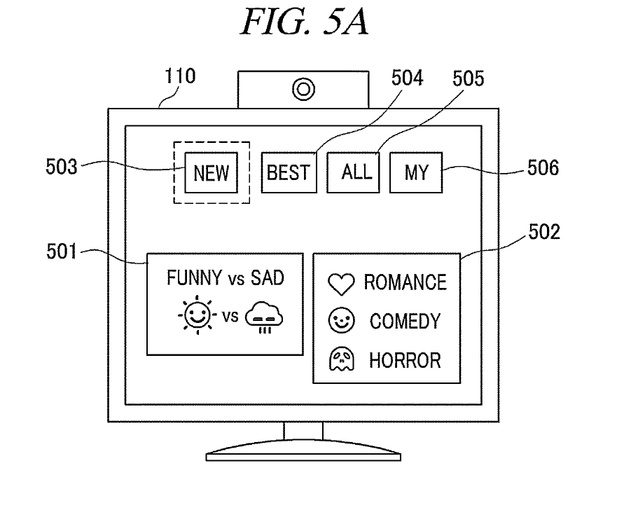

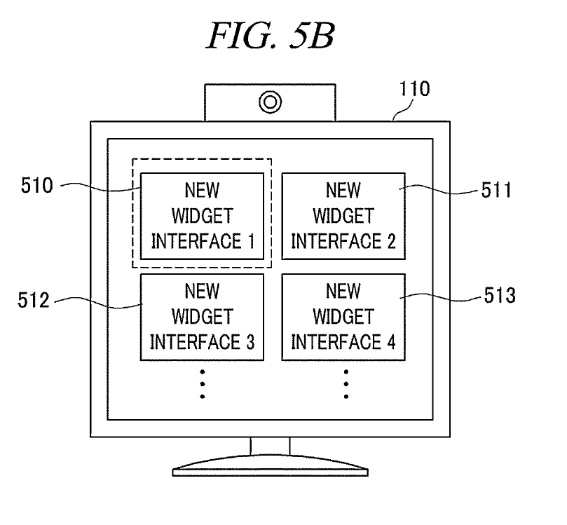

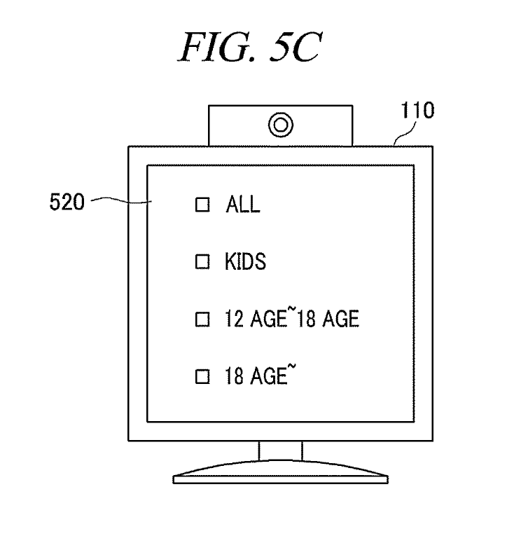

FIGS. 5A to 5C show another illustrative example of a device by which at least portions of widget interface management may be implemented, in accordance with various embodiments described herein. Second device 110, described above with regard to FIG. 1, may be configured to display multiple widget interfaces on a display that may be a part of, or communicatively coupled to, second device 110. For example, as depicted in FIG. 5A, second device 110 may be configured to display a first widget interface 501 and a second widget interface 502. Further, second device 110 may be configured to display multiple icons, each of which may represent an option to display the multiple widget interfaces. For example, but not as a limitation, as depicted in FIG. 5A, second device 110 may be configured to display an icon 503 that represents an option to display newly generated, or the latest, multiple widget interfaces. Further, second device 110 may be configured to display an icon 504 that represents an option to display top-rated, or the most popular, multiple widget interfaces. Further, second device 110 may be configured to display an icon 505 that may represent an option to display all widget interfaces. Further, second device 110 may be configured to display an icon 506 that may represent an option to display at least one widget interface that is preferred or selected by a user of second device 110. In some embodiments, server 115 may be configured to store, in a corresponding memory, the multiple widget interfaces in a time sequence of generating each of the multiple widget interfaces. Further, server 115 may be configured to transmit, to second device 110, at least some of the latest multiple widget interfaces as the newly generated widget interfaces, when server 115 receive an input to select icon 503 from second device 110. Further, server 115 may be configured to store, in the corresponding memory, the multiple widget interfaces in the order of recommendation numbers. Further, server 115 may be configured to transmit, to second device 110, at least some of the multiple widget interfaces which have the greatest recommendation numbers as the top-rated widget interfaces, when server 115 receive an input to select icon 504 from second device 110.

Further, second device 110 may be configured to receive an input to select an option to display the multiple widget interfaces, and to display the multiple widget interfaces on the display, based at least in part on the selected option. For example, but not as a limitation, second device 110 may be configured to transmit, to server 115, an input to select icon 503 that represents the option to display newly generated or the latest multiple widget interfaces, if second device 110 receive the input to select icon 503 that represents the option for displaying newly generated or the latest multiple widget interfaces. Server 115 may be configured to transmit, to second device 110, at least some newly generated widget interfaces in response to the input. For example, second device 110 may be configured to receive, from server 115, new widget interfaces 510, 511, 512, and 513 and as depicted in FIG. 5B, second device 110 may be configured to display new widget interfaces 510, 511, 512, and 513.

Further, second device 110 may be configured to receive an input to select a widget interface from among the multiple widget interfaces. Further, second device 110 may be configured to display, on the display, at least one of multiple icons that represent search parameters for video content or video content lists, which are associated with the selected widget interface. For example, but not as a limitation, as depicted in FIG. 5C, second device 110 may be configured to display search parameter icon 520 which is included in new widget interface 510, if second device 110 receives an input to select new widget interfaces 510.

Thus, FIGS. 5A to 5C show another illustrative example of a device by which at least portions of widget interface management may be implemented, in accordance with various embodiments described herein.

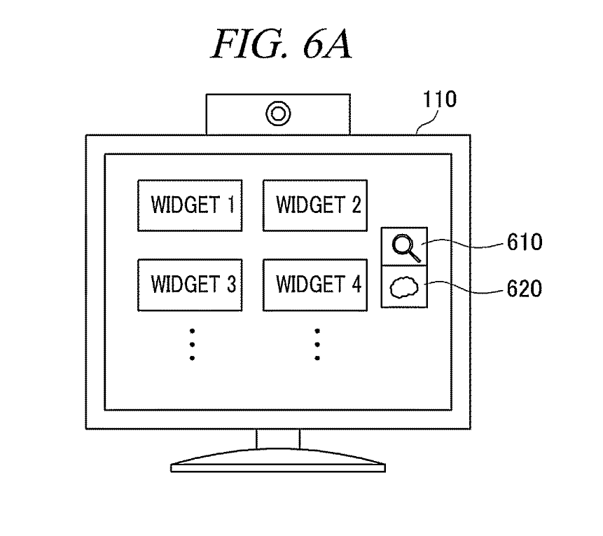

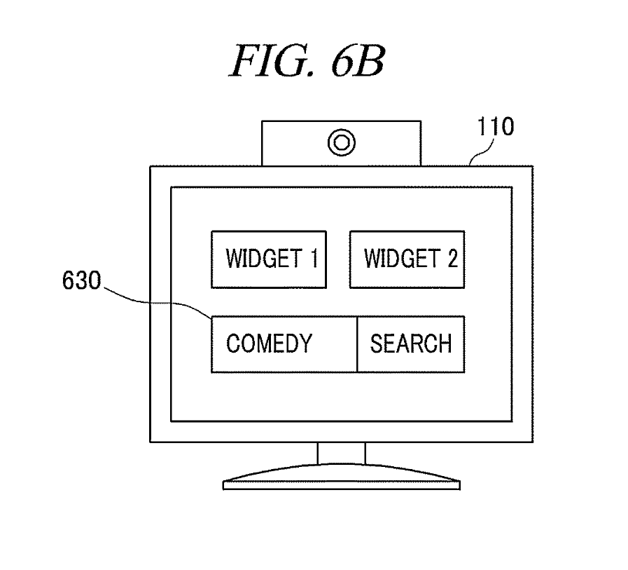

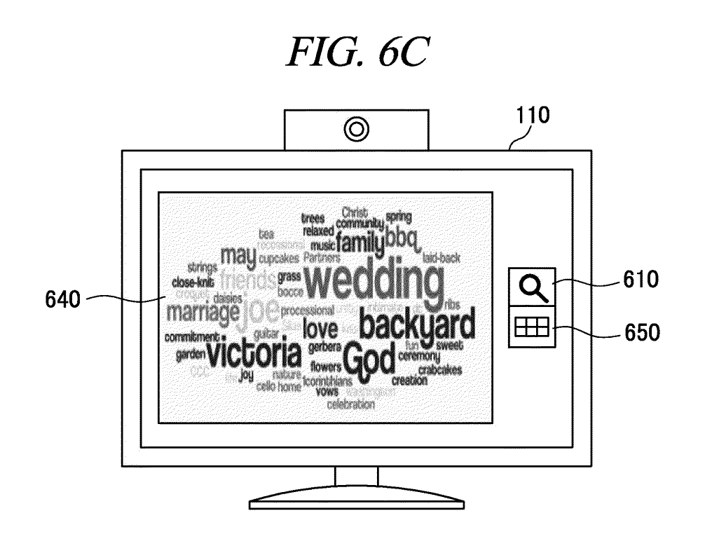

FIGS. 6A to 6C show still another illustrative example of a device by which at least portions of widget interface management may be implemented, in accordance with various embodiments described herein. As depicted in FIG. 6A, second device 110, described above with regard to FIG. 1, may be configured to display multiple widget interfaces on a display that may be a part of, or communicatively coupled to, second device 110. Further, second device 110 may be configured to display an icon 610 that may be configured to receive user input instructions to search for a widget interface. Further, second device 110 may be configured to display an icon 620 that may be configured to receive an input to show multiple keywords or titles that represent respective widget interfaces.

For example, as depicted in FIG. 6B, second device 110 may be configured to display a search area or a search image 630 that may be configured to receive a keyword or title of a widget interface which a user of second device 110 wishes to search for, when second device 110 receives a user input to select icon 610.

Further, for example, as depicted in FIG. 6C, second device 110 may be configured to transmit, to server 115, a request to transmit, to second device 110, multiple keywords or titles 640 that represent respective widget interfaces, when second device 110 receives an input to select icon 620. Further, second device 110 may be configured to receive, from server 115, multiple keywords or titles 640 in response to the request. Further, second device 110 may be configured to display multiple keywords or titles 640 in the shape of a cloud. Further, second device 110 may be configured to display an icon 650 that may be configured to receive an input to display multiple widget interfaces in the shape of a grid or a lattice. For example, second device 110 may be configured to display the multiple widget interfaces, which may be downloaded from server 115, in the shape of a grid as depicted in FIG. 6A, if second device 110 receives an input to select icon 650.

Thus, FIGS. 6A to 6C show still another illustrative example of a device by which at least portions of widget interface management may be implemented, in accordance with various embodiments described herein.

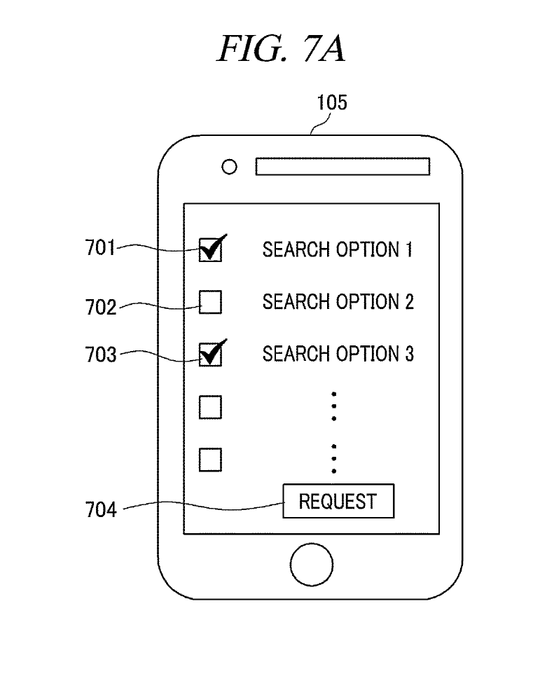

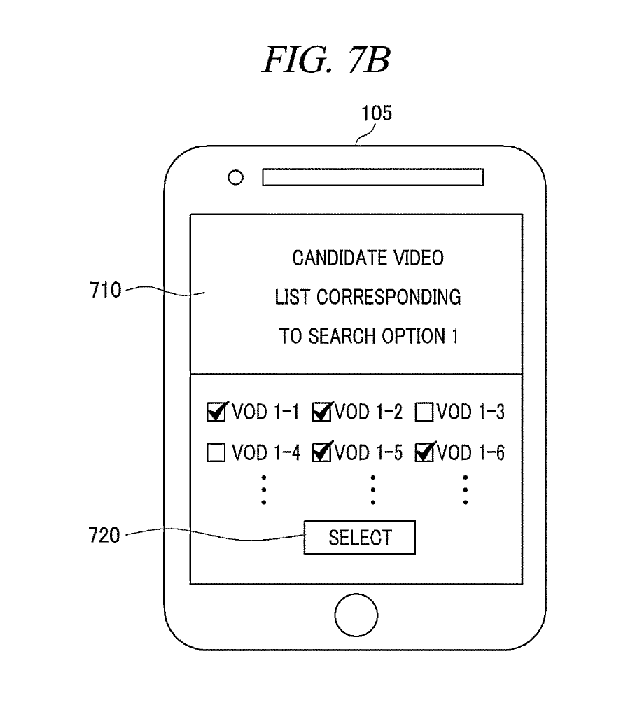

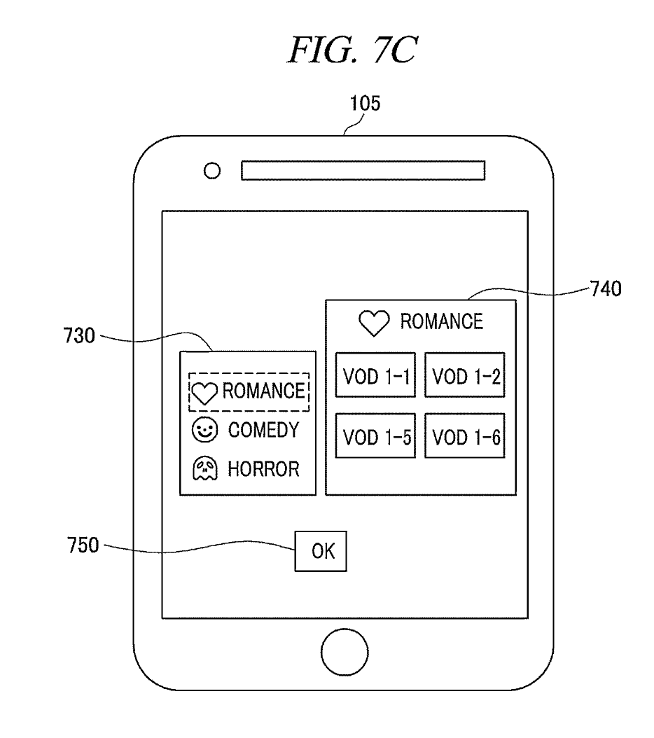

FIGS. 7A to 7C show an illustrative example of a device by which at least portions of widget interface management may be implemented, in accordance with various embodiments described herein. First device 105, described above with regard to FIG. 1, may be configured to transmit, to server 115, a request to generate a widget interface and at least one search parameter for video content. For example, but not as a limitation, as depicted in FIG. 7A, first device 105 may be configured to display a user interface 710 that includes selecting menu with boxes 701, 702, and 703 to receive an input to select search parameters for video content and an icon 704 to receive an input to transmit, to server 115, a widget interface generating request and the selected search parameters.

Further, as depicted in FIG. 7B, first device 105 may be configured to display a candidate list 710 of video content that corresponds to the selected search parameter. Further, first device 105 may be configured to receive user input to select video content included in list 710. Further, first device 105 may be configured to display an icon 720 to receive an input to transmit, to server 115, information regarding the video content which are selected by the user input. For example, the information regarding the selected video content may include an identifier of the selected video content, such as “vod 1-1”, “vod 1-2”, “vod 1-5” and “vod 1-6”. First device 105 may be configured to transmit, to sever 115, the information regarding the selected video content, when first device 105 receives an input to select icon 720.

Further, as depicted in FIG. 7C, first device 105 may be configured to display a widget interface 730 that includes icons that represents the selected search parameters for video content and a list 740 of video content that includes the selected video content. Further, first device 105 may be configured to display icon 750 to receive an input to confirm widget interface 730 and video content list 740. First device 105 may be configured to transmit, to server 115, a confirmation signal regarding widget interface 730 and video content list 740, when first device 105 receives an input to select icon 750. Then, server 115 may be configured to store widget interface 730 and video content list 740 in a memory, and to transmit widget interface 730 and video content list 740 to second device 110.

Thus, FIGS. 7A to 7C show an illustrative example of a device by which at least portions of widget interface management may be implemented, in accordance with various embodiments described herein.

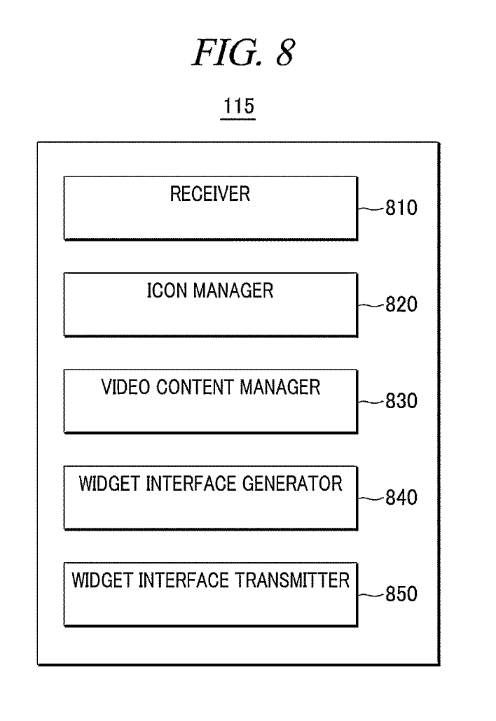

FIG. 8 shows an example configuration of a server 115 by which at least portions of widget interface management may be implemented, in accordance with various embodiments described herein. As depicted in FIG. 8, server 115 may include a receiver 810, an icon manager 820, a video content manager 830, a widget interface generator 840 and a widget interface transmitter 850. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of receiver 810, icon manager 820, video content manager 830, widget interface generator 840 and widget interface transmitter 850 may be included in an instance of an application hosted on server 115.

Receiver 810 may be configured to receive, from first device 105, a request to generate a widget interface and at least one search parameter for video content. Further, receiver 810 may be configured to receive, from second device 110, a request for video content that may be selected from a list of video content.

Icon manager 820 may be configured to determine and/or generate an icon that represents the search parameter for the video content.

Video content manager 830 may be configured to generate and/or determine a list of video content that corresponds to the received search parameter for the video content. In some embodiments, video content manager 830 may be configured to identify candidate video content that corresponds to the search parameter, and to generate the list of the video content based at least in part on the identified candidate video content. Video content manager 830 may be configured to perform processes that may be necessary for generating the list of the video content that corresponds to the received search parameter. For example, video content manager 830 may be configured to prepare and/or generate a candidate list of the identified candidate video content, and to transmit the generated candidate list of the candidate video content to first device 105 from which the search parameter was transmitted. Further, video content manager 830 may be configured to receive, from first device 105, a selecting input to select one or more video content from the candidate list of the candidate video content. Video content manager 830 may be configured to then generate the list of the video content that includes the selected video content.

Further, video content manager 830 may be configured to transmit, to second device 110, the video content that was requested by second device 110.

Widget interface generator 840 may be configured to generate the widget interface that may include the icon representing the search parameter for the video content and the list of the video content. Further, the widget interface, generated by widget interface generator 840, may include at least one of a review of video content, a synopsis of video content, a number of recommendations for video content, a poster of video content, or information about an actor of video content.

Widget interface transmitter 850 may be configured to transmit the generated widget interface to second device 110.

Thus, FIG. 8 shows an example configuration of server 115 by which at least portions of widget interface management may be implemented, in accordance with various embodiments described herein.

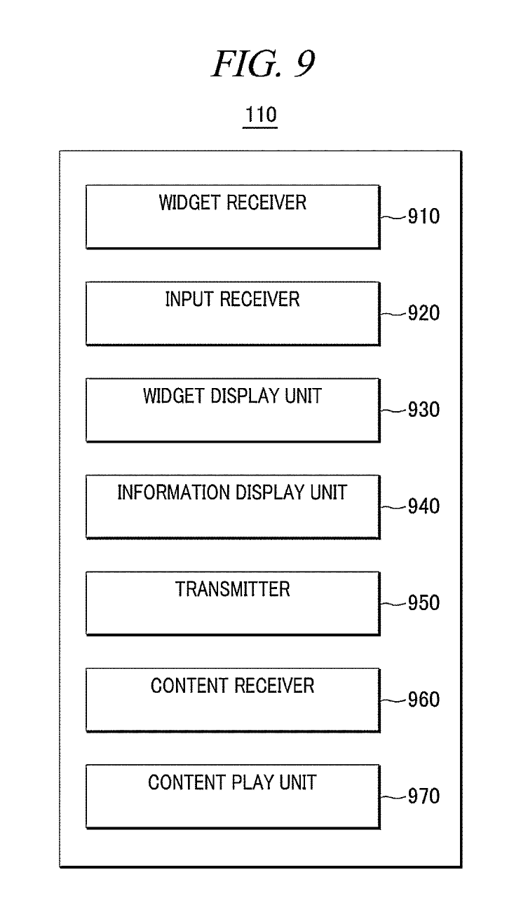

FIG. 9 shows an example configuration of a device by which at least portions of widget interface management may be implemented, in accordance with various embodiments described herein. As depicted in FIG. 9, for example, second device 110 may include a widget receiver 910, an input receiver 920, a widget display unit 930, an information display unit 940, a transmitter 950, a content receiver 960 and a content play unit 970. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of widget receiver 910, input receiver 920, widget display unit 930, information display unit 940, transmitter 950, content receiver 960 and content play unit 970 may be included in an instance of an application hosted on first device 105 or second device 110.

Widget receiver 910 may be configured to receive multiple widget interfaces from server 115. Each of the multiple widget interfaces may be associated with at least one list of video content that corresponds to a search parameter for video content. Further, widget receiver 910 may be configured to receive, from server 115, information regarding video content. As non-limiting examples, the information regarding the video content may include at least one of a review of the video content, a synopsis of the video content, a number of recommendations for the video content, a poster of the video content, or information about an actor of the video content.

Input receiver 920 may be configured to receive a user input to select a widget interface from among the received multiple widget interfaces. Further, input receiver 920 may be configured to receive a user input to select an option for displaying the multiple widget interfaces. Further, input receiver 920 may be configured to receive a user input to select video content from the list of the video content, which is included in the multiple widget interfaces.

Widget display unit 930 may be configured to display the received multiple widget interfaces on a display that may be part of, or communicatively coupled to, second device 110. In some embodiments, widget display unit 930 may be configured to display the received multiple widget interfaces on the display based at least in part on the selected option to display the multiple widget interfaces.

Information display unit 940 may be configured to display, on the display, the list of video content that may be associated with the widget interface which is selected from among the multiple widget interfaces.

Further, information display unit 940 may be configured to display, on the display, a first icon that may be configured to receive input instructions to search for video content that may be associated with the selected widget interface. Further, information display unit 940 may be configured to display, on the display, at least one of a second icon that may be configured to receive an input to recommend the selected widget interface, or a third icon that may be configured to show a number of recommendations for the selected widget interface.

Further, information display unit 940 may be configured to display, on the display, information regarding the selected video content. The information regarding the selected video content may be received by widget receiver 910 from server 115. As non-limiting examples, the information regarding the selected video content may include at least one of a review of the video content, a synopsis of the video content, a number of recommendations for the video content, a poster of the video content, or information about an actor of the video content.

Further, information display unit 940 may be configured to display, on the display, multiple keywords or titles that may represent the multiple widget interfaces. For example, but not as a limitation, information display unit 940 may be configured to display each of the multiple keywords or titles in various shapes or with various kinds of fonts or colors, based on a popularity of each widget interface or a number of recommendations for each widget interface.

Transmitter 950 may be configured to transmit, to server 115, a request for the selected video content.

Content receiver 960 may be configured to receive, from server 115, the requested video content.

Content play unit 970 may be configured to play or reproduce the received video content on the display.

Thus, FIG. 9 shows an example configuration of a device by which at least portions of widget interface management may be implemented, in accordance with various embodiments described herein.

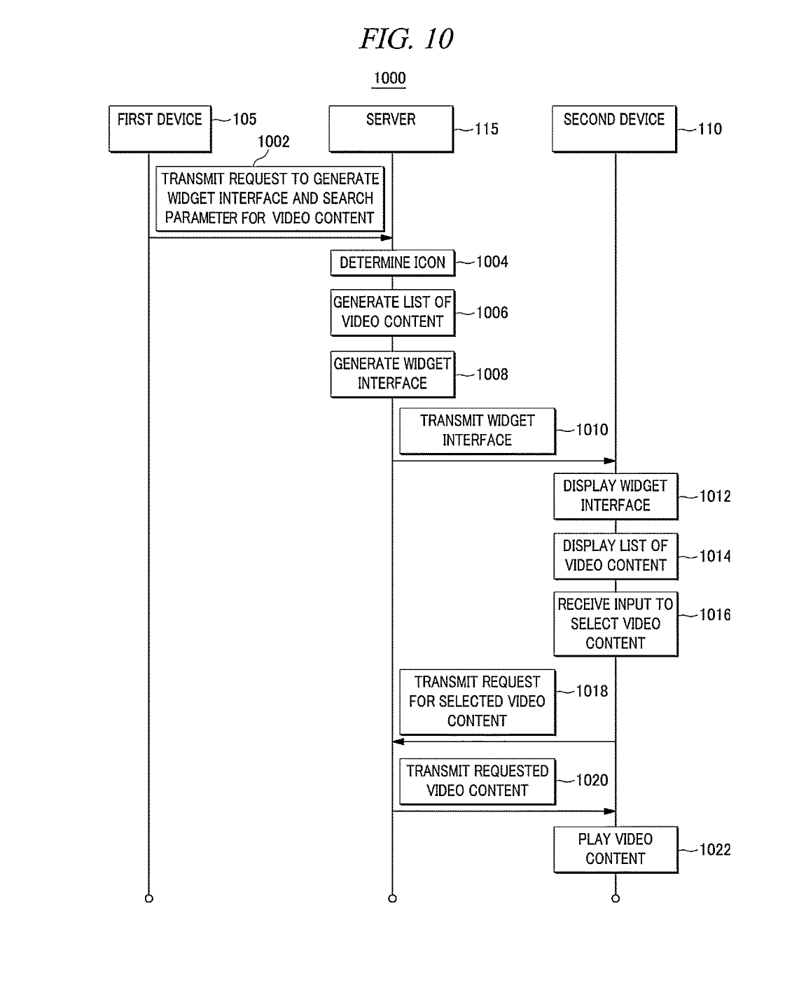

FIG. 10 shows an example processing flow 1000 of operations by which at least portions of widget interface management may be implemented, in accordance with various embodiments described herein. The operations of processing flow 1000 may be implemented in system configuration 10 including first device 105, second device 110, and server 115, as illustrated in FIG. 1. Processing flow 1000 may include one or more operations, actions, or functions as illustrated by one or more blocks 1002, 1004, 1006, 1008, 1010, 1012, 1014, 1016, 1018, 1020 and/or 1022. Although illustrated as discrete blocks, various blocks may be divided into additional blocks, combined into fewer blocks, or eliminated, depending on the desired implementation. Processing may begin at block 1002.

Block 1002 (Transmit Request to Generate Widget Interface and Search Parameter for Video Content) may refer to first device 105 transmitting, to server 115, a request to generate a widget interface and a search parameter for video content. Processing may proceed from block 1002 to block 1004.

Block 1004 (Determine Icon) may refer to server 115 determining an icon that may represent the search parameter for the video content that is received at block 1002. For example, the icon may refer to an image, a keyword, or a representation that represents the received search parameter for the video content. Processing may proceed from block 1004 to block 1006.

Block 1006 (Generate List of Video Content) may refer to server 115 generating a list of video content that may correspond to the search parameter that is received at block 1002. Processing may proceed from block 1006 to block 1008.

Block 1008 (Generate Widget Interface) may refer to server 115 generating a widget interface that may include the icon that is determined at block 1004, as well as the list of the video content that is generated at block 1006. Processing may proceed from block 1008 to block 1010.

Block 1010 (Transmit Widget Interface) may refer to server 115 transmitting, to second device 110, the widget interface that is generated at block 1008. Processing may proceed from block 1010 to block 1012.

Block 1012 (Display Widget Interface) may refer to second device 110 displaying the widget interface that is transmitted at block 1010 on a display that may be part of, or communicatively coupled to, second device 110. Second device 110 may display the icon that may be included in the widget interface and represents the search parameter for the video content on the display. Processing may proceed from block 1012 to block 1014.

Block 1014 (Display List of Video Content) may refer to second device 110 displaying the list of the video content that may be associated with the icon. At block 1014, second device 110 may display the list of the video content, when second device 110 receives a user input to select the icon. Processing may proceed from block 1014 to block 1016.

Block 1016 (Receive Input to Select Video Content) may refer to second device 110 receiving a user input to select video content from the list of the video content that may be displayed at block 1014. For example, second device 110 may receive a touch input to select video content from the list of the video content. Processing may proceed from block 1016 to block 1018.

Block 1018 (Transmit Request for Selected Video Content) may refer to second device 110 transmitting, to server 115, a request for the video content that is selected at block 1016. Processing may proceed from block 1018 to block 1020.

Block 1020 (Transmit Requested Video Content) may refer to server 115 transmitting, to second device 110, the video content which is requested at block 1018. Further, at block 1020, server 115 may transmit information regarding the requested video content to second device 110. For example, but not as a limitation, the information regarding the requested video content may include at least one of a review of the requested video content, a synopsis of the requested video content, a number of recommendations for the requested video content, a poster of the requested video content, or information about an actor of the requested video content. Processing may proceed from block 1020 to block 1022.

Block 1022 (Play Video Content) may refer to second device 110 playing the video content that is transmitted at block 1020, on the display. Further, at block 1022, second device 110 may display the information regarding the video content on the display.

Thus, FIG. 10 shows example processing flow 1000 of operations by which at least portions of widget interface management may be implemented, in accordance with various embodiments described herein.

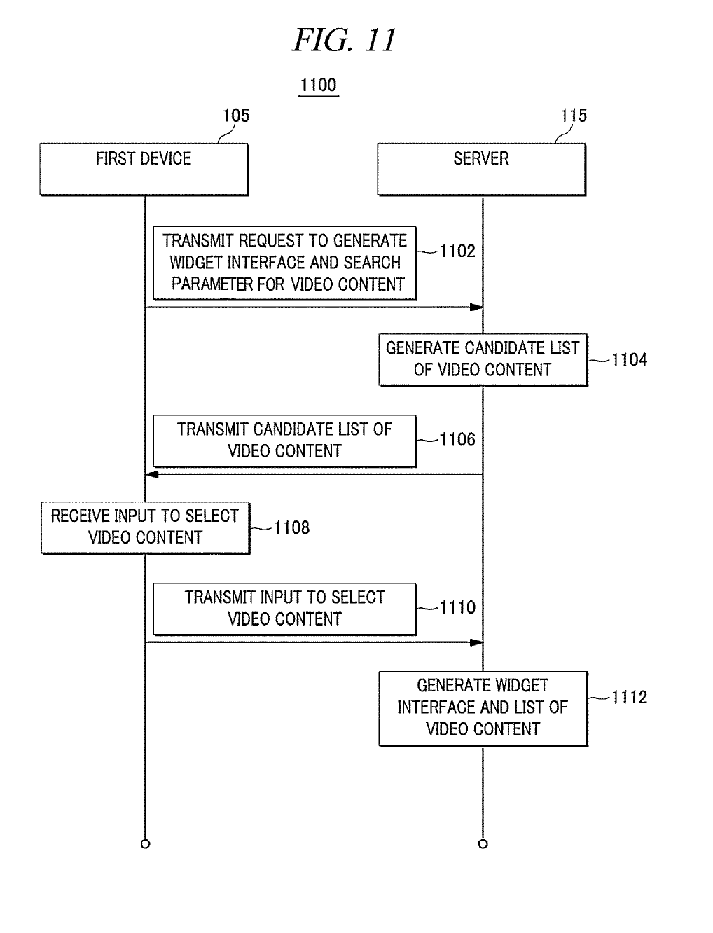

FIG. 11 shows another example processing flow 1100 of operations by which at least portions of widget interface management may be implemented, in accordance with various embodiments described herein. The operations of processing flow 1100 may be implemented in system configuration 10 including first device 105, second device 110, and server 115, as illustrated in FIG. 1. Processing flow 1100 may include one or more operations, actions, or functions as illustrated by one or more blocks 1102, 1104, 1106, 1108, 1110 and/or 1112. Although illustrated as discrete blocks, various blocks may be divided into additional blocks, combined into fewer blocks, or eliminated, depending on the desired implementation. Processing may begin at block 1102.

Block 1102 (Transmit Request to Generate Widget Interface and Search Parameter for Video Content) may refer to first device 105 transmitting, to server 115, a request to generate a widget interface and a search parameter for video content. Processing may proceed from block 1102 to block 1104.

Block 1104 (Generate Candidate List of Video Content) may refer to server 115 generating a candidate list of video content that corresponds to the search parameter that is received at block 1102. At block 1104, server 115 may search for and/or identify one or more video content that corresponds to the search parameter. Further, server 115 may generate the candidate list of the identified video content. Processing may proceed from block 1104 to block 1106.

Block 1106 (Transmit Candidate List of Video Content) may refer to server 115 transmitting, to first device 105, the candidate list of video content that is generated at block 1104. Processing may proceed from block 1106 to block 1108.

Block 1108 (Receive Input to Select Video Content) may refer to first device 105 receiving a selecting input to select video content from the candidate list of video content that is transmitted at block 1106. Processing may proceed from block 1108 to block 1110.

Block 1110 (Transmit Input to Select Video Content) may refer to first device 105 transmitting, to server 115, the selecting input to select video content from the candidate list of video content that is received at block 1108. Processing may proceed from block 1110 to block 1112.

Block 1112 (Generate Widget Interface and List of Video Content) may refer to server 115 generating the widget interface and a list of video content that includes the video content which is selected from the candidate list of video content.

Thus, FIG. 11 shows another example processing flow 1100 of operations by which at least portions of widget interface management may be implemented, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

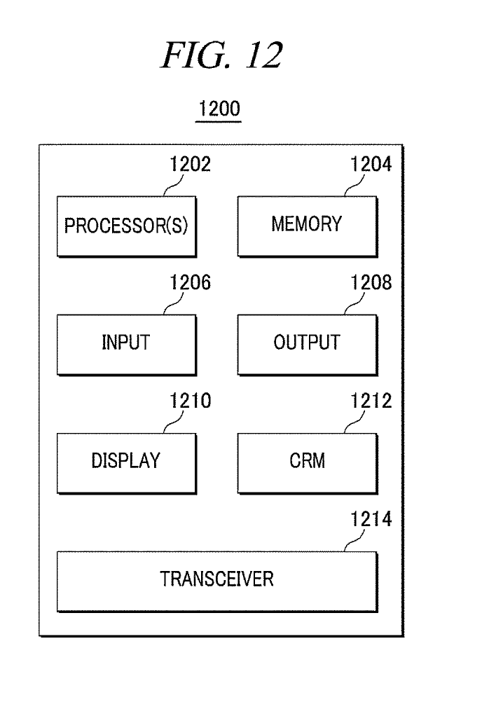

FIG. 12 shows an illustrative computing embodiment, in which any of the processes and sub-processes of widget interface management may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 1200 may typically include, at least, one or more processors 1202, a system memory 1204, one or more input components 1206, one or more output components 1208, a display component 1210, a computer-readable medium 1212, and a transceiver 1214.

Processor 1202 may refer to, e.g., a microprocessor, a microcontroller, a digital signal processor, or any combination thereof.

Memory 1204 may refer to, e.g., a volatile memory, non-volatile memory, or any combination thereof. Memory 1204 may store, therein, an operating system, an application, and/or program data. That is, memory 1204 may store executable instructions to implement any of the functions or operations described above and, therefore, memory 1204 may be regarded as a computer-readable medium.

Input component 1206 may refer to a built-in or communicatively coupled keyboard, touch screen, or telecommunication device. Alternatively, input component 1206 may include a microphone that is configured, in cooperation with a voice-recognition program that may be stored in memory 1204, to receive voice commands from a user of computing device 1200. Further, input component 1206, if not built-in to computing device 1200, may be communicatively coupled thereto via short-range communication protocols including, but not limitation, radio frequency or Bluetooth.

Output component 1208 may refer to a component or module, built-in or removable from computing device 1200, that is configured to output commands and data to an external device.

Display component 1210 may refer to, e.g., a solid state display that may have touch input capabilities. That is, display component 1210 may include capabilities that may be shared with or replace those of input component 1206.

Computer-readable medium 1212 may refer to a separable machine readable medium that is configured to store one or more programs that embody any of the functions or operations described above. That is, computer-readable medium 1212, which may be received into or otherwise connected to a drive component of computing device 1200, may store executable instructions to implement any of the functions or operations described above. These instructions may be complimentary or otherwise independent of those stored by memory 1204.

Transceiver 1214 may refer to a network communication link for computing device 1200, configured as a wired network or direct-wired connection. Alternatively, transceiver 1214 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A system, comprising:
a server configured to:
receive, from a first device, a request to generate a widget interface and a search parameter for video content,
generate a list of video content corresponding to the search parameter for the video content,
generate the widget interface associated with the generated list of video content, and
transmit the generated widget interface; and
a second device configured to:
receive the transmitted widget interface,
receive an input to select the transmitted widget interface from among a plurality of widget interfaces, and
display the list of the video content associated with the selected widget interface.

2. The system of claim 1, wherein the widget interface includes an icon that represents the received search parameter for the video content, and
wherein the second device is further configured to display the icon associated with the selected widget interface.

3. The system of claim 1, wherein the second device is further configured to:
receive an input to select an option for displaying the plurality of widget interfaces, and
display the plurality of widget interfaces based at least in part on the selected option.

4. The system of claim 2, wherein the server is further configured to determine the icon that represents the received search parameter for the video content.

5. The system of claim 4, wherein the server is further configured to:
identify the video content that corresponds to the search parameter for the video content, and
generate the list of the video content based at least in part on the identified video content.

6. The system of claim 5, wherein the server is further configured to:
transmit a candidate list of the identified video content to the first device,
receive, from the first device, a selecting input to select one or more video content from the candidate list of the identified video content, and
generate the list of the video content that includes the selected one or more video content.

7. The system of claim 1, wherein the second device is further configured to:
receive an input to select video content from the list of the video content,
transmit a request for the selected video content to the server, and
wherein the server is further configured to transmit the requested video content to the second device.

8. The system of claim 1, wherein the second device is further configured to:
receive an input to select video content from the list of the video content,
receive, from the server, information that includes at least one of a review of the selected video content, a synopsis of the selected video content, a number of recommendations for the selected video content, a poster of the selected video content, or information about an actor of the selected video content, and
display the received information.

9. A server, comprising:
a receiver configured to receive, from a first device, a request to generate a widget interface and a search parameter for video content;
an icon manager configured to determine an icon that represents the received search parameter for the video content;
a video content manager configured to determine a list of the video content that corresponds to the search parameter for the video content;
a widget interface generator configured to generate the widget interface that includes the icon and the list of the video content; and
a widget interface transmitter configured to transmit the generated widget interface to a second device.

10. The server of claim 9, wherein the receiver is further configured to receive, from the second device, a request for video content selected from the list of the video content, and
wherein the video content manager is further configured to transmit the requested video content to the second device.

11. The server of claim 9, wherein the video content manager is further configured to:
identify the video content that corresponds to the search parameter for the video content, and
generate the list of the video content based at least in part on the identified video content.

12. The server of claim 11, wherein the video content manager is further configured to:
transmit a candidate list of the identified video content to the first device,
receive, from the first device, a selecting input to select one or more video content from the candidate list of the identified video content, and
generate the list of the video content that includes the selected one or more video content.

13. The server of claim 9, wherein the widget interface further includes at least one of a review of the video content, a synopsis of the video content, a number of recommendations for the video content, a poster of the video content, or information about an actor of the video content.

14. A device, comprising:
a widget receiver configured to receive, from a server, a plurality of widget interfaces that are associated with a plurality of lists of video content;
a widget display unit configured to display the received plurality of widget interfaces;
an input receiver configured to receive an input to select a widget interface from among the displayed plurality of widget interfaces; and
an information display unit configured to display a list of video content that is associated with the selected widget interface.

15. The device of claim 14, wherein the input receiver is further configured to receive an input to select an option for displaying the plurality of widget interfaces, and
wherein the widget display unit is further configured to display the plurality of widget interfaces based at least in part on the selected option.

16. The device of claim 14, wherein the information display unit is further configured to display a first icon that is configured to receive input instructions to search for the video content associated with the selected widget interface.

17. The device of claim 16, wherein the information display unit is further configured to display at least one of a second icon that is configured to receive an input to recommend the selected widget interface, or a third icon that is configured to show a number of recommendations for the selected widget interface.

18. The device of claim 14, wherein the input receiver is further configured to receive an input to select video content from the list of the video content,
wherein the device further comprises:
a transmitter configured to transmit a request for the selected video content to the server;
a content receiver configured to receive, from the server, the requested video content; and
a content play unit configured to play the received video content.

19. The device of claim 14, wherein the input receiver is further configured to receive an input to select video content from the list of the video content, and
wherein the information display unit is further configured to display at least one of a review for the selected video content, a synopsis of the selected video content, a number of recommendations for the selected video content, a poster of the selected video content, or information about an actor of the selected video content.

20. The device of claim 14, wherein the information display unit is further configured to display a plurality of keywords that represent the plurality of widget interfaces.

21. The device of claim 14, wherein each of the plurality of widget interfaces includes an icon that represents a search parameter for the video content, and
wherein the information display unit is further configured to display the list of the video content that corresponds to the search parameter for the video content.
